(19) United States
(12) Patent Application Publication
(10) Pub. No.: US 2012/0322924 A1
(43) Pub. Date: Dec. 20, 2012

(54) METHOD FOR PRODUCING HIGH SILICA LOADED POLYMERIC RUBBER COMPOSITE WITH A PRETREATED SILICA

(75) Inventors: Mark Arigo, Baton Rouge, LA (US); Jorge Soto, Baton Rouge, LA (US); Subir Debnath, Baton Rouge, LA (US)

(73) Assignee: LION COPOLYMER, LLC, Baton Rouge, LA (US)

(21) Appl. No.: 13/525,199

(22) Filed: Jun. 15, 2012

Related U.S. Application Data
(60) Provisional application No. 61/497,312, filed on Jun. 15, 2011.

(51) Int. Cl. C08L 9/08; C08K 3/20; C08K 5/18; C08K 3/04; C08K 5/548; C08K 5/53

(52) U.S. Cl. 524/132; 524/262; 524/255

(57) ABSTRACT

A method for making a high silica loaded polymeric composition by forming a pretreated silica by creating an aqueous slurry with a silica and a silane, mixing a solvent with the silane and adding the mixture to the silica, or spraying silane on the silica allowing the liquids to be absorbed into the silica. The method includes coupling the silane onto the silica, adding the pretreated silica to a carrier, forming a slurry, heating the slurry, and mixing preheated polymeric rubber latex with the heated slurry to form a latex slurry, then blending a coagulant with the latex slurry while stirring and allowing coagulation of the latex slurry to form the high silica loaded polymeric rubber composite.

### CROSS REFERENCE TO RELATED APPLICATIONS

The current application claims priority and the benefit of co-pending U.S. Provisional Patent Application Ser. No. 61/497,312 filed on Jun. 15, 2011, entitled “METHOD FOR PRODUCING A HIGH SILICA LOADED POLYMERIC RUBBER COMPOSITE WITH A PRETREATED SILICA.” This reference is incorporated herein in its entirety.

### FIELD

The present embodiments generally relate to a method for forming a high silica loaded polymeric rubber composite.

### BACKGROUND

A need exists for a composite for making tires that increases the efficiency of gas consumption by vehicles.

A need exists for a composite for making hoses, conveyor belts, shoes soles, retreads, and the like that is less expensive than already existing alternatives.

A need exists for a method for making a polymeric composite having a pretreated component, providing improved processablity of the composite.

A need exists for a method to make a polymeric rubber composite loaded with silica that requires less mixing energy to disperse silica in rubber.

A need exists for a method for making a composite that releases ethanol during pretreatment due to a coupling of ethoxy groups or methoxy groups with silanol groups of silica; thereby forming a hydrolysis reaction and significantly reducing post production ethanol/volatile organic compounds (VOC) evolution, such as at a consumer's facility.

A need exists for a method for making a composite that improves safety in a plant by reducing the presence of ethanol in the presence of silica powders; thereby reducing the chance of an explosion from a reaction between ethanol and silica powder.

The present embodiments meet these needs.

### BRIEF DESCRIPTION OF THE DRAWINGS

N/A

### DETAILED DESCRIPTION OF THE EMBODIMENTS

Before explaining the present compound and method in detail, it is to be understood that the compound and method are not limited to the particular embodiments and that the embodiments can be practiced or carried out in various ways.

The present embodiments relate to a method to make a high silica loaded polymeric rubber composite.

The high silica loaded polymeric rubber composite can be used to make tires that increase the efficiency of gas consumption of vehicles. For example, tires produced using the high silica loaded polymeric rubber composite can allow vehicles that would otherwise have a miles-per-gallon rating lower than 40 to have a miles-per-gallon rating of up to 40.

The high silica loaded polymeric rubber composite can also be used to make hoses, conveyor belts, shoes soles, and other such articles of manufacture. The high silica loaded polymeric rubber composite can be used to make articles of manufacture at a cheaper rate when compared with existing alternatives such as retreads for tires.

The high silica loaded polymeric rubber composite can include a pretreated silica, which can provide for improved processablity of the composite because the silica is compatible with the rubber matrix and pre-dispersed in the matrix.

The high silica loaded polymeric rubber composite can require less mixing energy to disperse silica in rubber because the silica is pre-dispersed in the rubber matrix.

The method produces a resultant material that will release less volatile organic compounds, such as ethanol, in-part because a coupling of ethoxy groups or methoxy groups with silanol groups of silica, significantly reducing the possibility of ethanol or methanol evolution.

The method can produce a resultant material that can improve safety in a plant by reducing the presence of volatile organic compounds in a plant containing the resultant product, thereby reducing the chance of a fire or an explosion or a major incident, from a reaction with ethanol vapors.

The invention will improve the American economy because the method can produce tires with improved gas mileage allowing compliance with a corporate average fleet economy (CAFÉ) regulation, such as 35 mpg, which allows the American consumers to save money on gasoline. This product will also prevent fines from being levied on American car manufacturers.

The method for making the high silica loaded polymeric rubber composite can include forming a pretreated silica.

The pretreated silica can be silica that is modified to have the following physical and/or chemical parameters: a loss on drying ranging from about 0.1 percent to about 10 percent as determined by the Deutsches Institut Fur Normung E.V. (DIN), International Organization for Standardization (ISO) 787/2; a loss on ignition ranging from 2 percent to 25 percent as determined by the Deutsches Institut Fur Normung E.V., International Organization for Standardization (ISO) 3262/11; a methanol wettability ranging from 20 percent to 80 percent (titrated); a carbon content ranging from 1 percent to 30 percent, and a sulfur content ranging from 0.1 weight percent to 10 weight percent.

The pretreated silica can be formed by creating an aqueous slurry with a silica and a silane. The aqueous slurry can have 10 weight percent to 20 weight percent silica based on the total weight of the slurry. 1-25 parts silane per 100 parts by weight of silica can be used in the aqueous slurry.

An example of a silica usable herein can be HISIL from PPG known as HISIL 233, that has the following chemical/physical properties: 113 meters squared per gram.

In one or more embodiments, the silane can be an organosilicon, which can be derived from an organic silane having the chemical structure

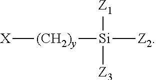

Within the chemical structure, the X can be a functional group selected from the group consisting of: an amino group, a polyamino alkyl group, a mercapto group, a thiocyanato group, an epoxy group, a vinyl group, a halogen, an acryloxy group, and a methacryloxy group. Within the chemical structure, the y can be an integer equal to or greater than 0. Within the chemical structure, the Z₁, Z₂, and Z₃ can each be independently selected from the group consisting of hydrogen, alkoxy, halogen, and hydroxyl.

In one or more embodiments, the silane can be an organosilicon derived from an organic silane having the structure: Z₁Z₂Z₃Si(CH₂)_{y}X(CH₂)_{y}SIZ₁Z₂Z₃. Within the structure, X can be a polysulfide, y can be an integer equal to or greater than 1, and Z₁, Z₂, and Z₃ can each be independently selected from the group consisting of hydrogen, alkoxy, halogen, and hydroxyl.

The organosilicon can be bonded to a surface of the silica. The amount of the organosilicon that is bonded to the surface of the silica can range from about 2 weight percent to about 25 weight percent of the silica.

The organosilicon can have three readily hydrolyzable groups attached directly to a silicon atom of the organosilicon.

The organosilicon can have at least one organic group attached directly to the silicon atom of the organosilicon. The organic group can contain at least one functional group.

The rubber component can be a polymeric rubber latex such as styrene-butadiene rubber, acrylonitrile-butadiene rubber, polyvinylchloride, acrylonitrile-butadiene-styrene polymer, carboxylated styrene butadiene, carboxylated acrylonitrile-butadiene, styrene-acrylonitrile copolymer, polybutadiene, polyisoprene, polychloroprene, neoprene, polybutadiene-isoprene, or combinations thereof.

The rubber component also may be a polymeric rubber latex of copolymers including a copolymer of: styrene and butadiene, styrene and isoprene, styrene and acrylonitrile, or butadiene and acrylonitrile.

Three different methods can be used to deposit the coupling agent on the silica.

One method is by creating an aqueous slurry with a silica and a silane, using an elevated temperature for a period of time to initiate deposition of the silane, wherein the silane at least partially deposits into the silane.

The silane is coupled to the silica, by being is added to a carrier such as water, forming a slurry.

Next, an elevated temperature, is used, such as a temperature ranging from about 70 degrees Fahrenheit to about 180 degrees Fahrenheit on the slurry forming a heated slurry.

The elevated temperature is applied to the aqueous slurry for a time period long enough to initiate deposition of the silane on the silica, such as a time period ranging from about 4 hours to 48 hours depending somewhat on the temperature employed.

A second method is by mixing a solvent with the silane, adding the mixed solvent and silane to the silica and using an elevated temperature for a period of time, initiate the deposition of the silane on the silica and the coupling. The silane at least partially deposits onto the silica.

In one or more embodiments, the mixture of two silanes can be coupled to the silica and can be formed by mixing the plurality of silanes together, in a dry form, and two, three, or four silanes can be used. The mixed silanes are then added to a solvent such a toluene, hexane, or another hydrocarbon solvent. The mixture of the solvent and plurality of silanes is then added to the silica. As an example, from about 40 weight percent to about 80 weight percent of solvent, and 1-25 parts of each silane per 100 parts by weight of silica can be blended to achieve coupling of the silanes on the silica.

The third method is by spraying the silane onto the silica and using an elevated temperature for at least a period of time to initiate deposition of the silane.

The silica can be coupled to the silane coupling agents using a spraying of the silica, such as with an air carrier, or simply with pressure from a pump onto silica in a ribbon blender or a fluidized bed.

For example, about 10 grams of silane can be sprayed on 100 grams of silica.

An acid can be used as catalyst of the reaction, such as acetic acid.

PH controllers can also be used to facilitate silane coupling at a given pH.

Elevated temperature, such as a temperature ranging from about 50 degrees Celsius to about 150 degrees Celsius, can be used to for a period of time during spraying to initiate deposition of the silane.

Mixing of the sprayed silane into the silica can be performed using a ribbon blender at a rate ranging from 5 revolutions-per-minute to 20 revolutions-per-minute, or an internal batch mixer, such as a Banbury Mixer available from Farrel Corporation of Ansonia, Conn. Mixing of the sprayed silane into the silica can also be performed using a fluidized bed.

The method can include adding the pretreated silica to a carrier, such as water, to form a slurry.

The slurry of the carrier and the pretreated silica can have from about 5 weight percent to about 40 weight percent of the pretreatment silica, and from about 60 weight percent to about 95 weight percent of the carrier.

The method can include forming a heated slurry by heating the slurry to a temperature ranging from 20 degrees Celsius to 70 degrees Celsius, until the slurry reaches a temperature equivalent to a temperature of a preheated polymeric rubber latex. In one or more embodiments, heating of the slurry can initiate coagulation.

The preheated polymeric rubber latex can be from one or more of the list of rubbers, including styrene-butadiene rubber, acrylonitrile-butadiene rubber, polyvinylchloride, acrylonitrile-butadiene-styrene polymer, carboxylated styrene butadiene, carboxylated acrylonitrile-butadiene, styrene-acrylonitrile copolymer, polybutadiene, polyisoprene, polychloroprene, neoprene, polybutadiene-isoprene, natural rubber, or combinations thereof.

Similarly, the preheated polymeric rubber latex can be a copolymer of: styrene and butadiene, styrene and isoprene, styrene and acrylonitrile, butadiene and acrylonitrile, or combinations thereof.

The method can include mixing the preheated polymeric rubber latex with the heated slurry to form a latex slurry.

The preheated polymeric rubber latex can be mixed with the heated slurry at a temperature of about 70 degrees Celsius and for a time period of sufficient to obtain a uniform mixture as observed by visual inspection.

The method can include coagulating the latex slurry to form the high silica loaded polymeric rubber composite with 1 weight percent to 35 weight percent silica and 65 weight percent to 99 weight percent of the polymeric rubber.

In one or more embodiment, the high silica loaded polymeric rubber composite can have from about 5 parts per hundred rubber to about 120 parts per hundred rubber (phr) of the pretreated silica.

Coagulating the latex slurry can include adding to the latex slurry: a solution of calcium chloride, zinc chloride, salts of aluminum, salts of magnesium, sulfuric acid, citric acid coagulate, ferric chloride, isopropanol, or combinations thereof.

For example, on or more embodiments can include blending calcium chloride in water to dilute from about 0.5 weight percent to about 5 weight percent of the calcium chloride in the water; thereby forming a calcium chloride solution as the coagulant.

The method can include adding the latex slurry to the coagulant, such as the calcium chloride solution, while continually stirring. The coagulant is added to the latex slurry at a rate of 10 gallons a minute, with the coagulate at an ambient temperatures and the latex at 70 degrees Celsius, a pressure of 1 atm.

The method can include allowing coagulation of the latex slurry, such as for about 30 seconds to 10 minutes, to form the high silica loaded polymeric rubber composite.

The coagulated high silica loaded polymeric rubber composite can then be recovered.

The formed high silica loaded polymeric rubber composite can have the following chemical/physical properties: a Mooney viscosity (UMS 4+4 at 100 Celsius) of 90 and ash of 35 percent.

### Example 1

### Exemplary Process to Treat Silica with a Silane Coupling Agent Via an Incipient Wetness Technique Using Solvent

First a silane coupling agent, acid, and organic solvent can be mixed at room temperature for a time period of 8 hours, such that the total volume is approximately the same as a pore volume of a silica, which can be from about 2.5 to about 3 times the weight of the silica. The silane coupling agent can be Si69™ from Evonik, acid such as acetic acid, and organic solvent such as hexane, can be mixed until well dispersed and/or dissolved.

In one or more embodiments, the silane coupling agent can be a bifunctional, sulfur-containing organosilane often used in the rubber industry in combination with white fillers that carry silanol groups, such as those available from Evonik Industries of AG Rellinghauser Straβe Essen, Germany. The silane coupling agent can be used in an amount ranging from about 4 weight percent to about 12 weight percent of the untreated precipitated silica powder.

The acid can be 2 weight percent of the total formulation.

The 50 weight percent organic solvent can be hexane or another organic solvent in which both silane and the acid are dissolvable within.

Next, the mixture of silane coupling agent, acid, and organic solvent can be added to an untreated precipitated silica powder and thoroughly mixed therein to wet the untreated precipitated silica powder, which can be performed at a temperature of such as room temperature until all the liquid is absorbed in the silica powder

For example, 100 grams of the untreated precipitated silica powder can be mixed with 10 grams of the silane coupling agent, 2 grams of the acid, and 300 ml of the hexane, such as in a pan and then in a heated oven at 80 degrees centigrade.

The untreated precipitated silica powder can be Hi-Sil 233 available from PPG Industries of Pittsburgh, Pa., which is a synthetic, white, amorphous silicon dioxide powder.

The mixture of the silane, acid, organic solvent, and untreated precipitated silica powder can be dried, such as for a time period of about 8 hours thereby drying off any volatile solvent and depositing the silane and acid in the silica, forming a dried product of pretreated silica.

The dried product of pretreated silica can be heat treated to promote hydrolysis and condensation reactions of the silane in order to covalently bond the silane to the silica surface.

The dried product of pretreated silica can then be tested for carbon and sulfur content using elemental analysis to determine the silane content on the silica.

The dried product of pretreated silica can be used in rubber formulations, such as a polymeric rubber latex, as the pretreated silica will have improved compatibility with the rubber formulations.

The dried product of pretreated silica can be incorporated into emulsion polymeric rubber latex, such as styrene-butadiene rubber, through a wet master batch process as described herein.

### Example 2

### Forming a Pretreated Silica by Creating an Aqueous Slurry

The aqueous slurry can be created by adding mixing 1.5 grams of silane and 3 grams of isopropanol and 0.1 grams of acetic acid, and 3 grams of water. The silane can be Silquest A-189.

The components are mixed at a high speed for about 10 minutes to 20 minutes until the mixture forms a clear liquid. Then 3 grams of water can be added, and mixed again for about 15 minutes to 20 minutes.

In a separate vessel, 2 pounds of water are blended with 0.5 pounds of silica about 15 minutes to wet and disperse the silica. The aqueous silane solution from the previous step is added. pH in the vessel of the two fluids is increased to 7.5 to 8 pH, using 25 percent sodium hydroxide. The vessel is then heated to 170 degrees Fahrenheit for about 4 hours. The heated mixture is allowed to cool to 140 degrees Fahrenheit, and then it is added to a preheated polymer rubber latex at about the same elevated temperature.

During the 4 hours of heating at 170 degrees, the silane is deposited onto the silica. The silane can at least partially deposit on the silica, and at least a portion of the silane can bond to the silica.

### Example 3

### Forming a Pretreated Silica by Spraying Silane onto Silica Using an Air Carrier and Mixing the Sprayed Silane into the Silica Using a Ribbon Blender

5 pounds of silica is added to a ribbon blender.

0.5 pounds of Si69™ is sprayed over the bed of silica with 0.1 pounds of acetic acid and allowed to tumbler at ambient temperature for about 1 hour.

The silane can be sprayed using a pump to increase fluid pressure through a narrow tube with little pin holes using a conical flow pattern.

The temperature is ramped up to 120 degrees Celsius and blended at the elevated temperature for 2 hours in the ribbon blender. The blender is allowed to cool to ambient temperature and the treated silica is discharged from the blender.

The treated silica is then weighed to produce 17 weight percent slurry in water. The silica and water are stirred at room temperature under high shear blending conditions for about an hour.

### Example 4

### Forming a High Silica Loaded Polymeric Rubber Composite Using Pretreaded Silica

The pretreated silica created by Example 1, Example 2, and/or Example 3 form the slurry.

The slurry is then heated forming a heated slurry, A preheated polymeric rubber latex is added to the heated slurry to form a high silica loaded polymeric rubber composite.

Next, the slurry can be added to the preheated polymeric rubber latex such that the preheated polymeric rubber latex has from 5 parts per hundred rubber to 120 parts per hundred rubber of the pretreated silica; thereby forming a latex slurry.

As an example, about 17 pounds of preheated polymer rubber latex with 21 wt % solids and 0.1 pounds non-staining antioxidant Naugard™ RM51 emulsion, and 1.3 pounds of Ergon B0300 oil emulsion are blended at a temperature of 70 degrees Celsius for a time period of 5 minutes forming a latex slurry.

3.3 pounds of treated silica in 16.4 pounds of water at ambient temperature are blended for about 1 hour forming a slurry. 0.2 pounds of carbon black is then mixed with water to form a carbon black slurry. 5.5 pounds of carbon black slurry is added at ambient temperatures to the slurry and then heated to 70 degrees Celsius forming a heated slurry.

The heated slurry is then mixed with the latex slurry at a temperature of about 70 degrees Celsius for a time period of about 2 minutes until uniform mixing is achieved by visual inspection. Coagulant is slowly added to change the pH of the blend to a desired pH to provide desired coagulated crumb rubber properties.

In an embodiment, prior to mixing the preheated polymeric rubber latex with the heated slurry, antioxidant can be added to the preheated polymeric rubber latex.

In embodiments, wherein an oil extender is added to the preheated rubber latex, a high silica loaded polymer rubber composite can be formed with 1 weight percent to 35 weight percent of pretreated silica, from 1 weight percent and 35 weight percent of an oil extender, and 30 weight percent to 98 weight percent of polymeric rubber latex. An example of a usable oil extender is SANDEX 8000 EU oil—with a lower viscosity and improved processability.

In embodiment, wherein an antioxidant is added to the preheated polymeric rubber latex a high silica loaded polymer rubber composite is formed with 1 weight percent to 35 weight percent of pretreated silica, from 0.1 weight percent to 2 weight percent of an antioxidant, and 67 weight percent to 99 weight percent of polymeric rubber latex. Examples of usable antioxidants include non-staining Nauguard RM 51 from Chemtura, or a staining antioxidant known as Santoflex 134PD from Flexsys America.

Usable carbon black slurry can be formed from 4 to 6 wt % carbon black in water, and used to form compositions of the high silica loaded polymer rubber composite is 1 weight percent to 35 weight percent silica, 1 weight percent to 49 weight percent of carbon black, and 16 weight percent to 98 weight percent polymeric rubber, forming a formulation with an improved tear strength.

Embodiments of the invention include articles made of the high silica loaded polymeric rubber composite which can be a truck tire, a pneumatic tire, an off road tire, an earth moving equipment tire, a farm equipment tire, bicycle tires, ATV tires, a wagon tire, a retread, a belt, a shoe sole, or a hose.

While these embodiments have been described with emphasis on the embodiments, it should be understood that within the scope of the appended claims, the embodiments might be practiced other than as specifically described herein.

What is claimed is:

1. A method for forming a high silica loaded polymeric rubber composite comprising:
a. forming a pretreated silica, wherein the pretreated silica is modified to have the following physical and/or chemical parameters: a loss on drying ranging from 0.1 percent to 10 percent, a loss on ignition ranging from 2 percent to 25 percent, a carbon content ranging from 1 weight percent to 20 weight percent, and wherein the pretreated silica is formed by:
(i) creating an aqueous slurry with a silica and a silane, and using an elevated temperature for a period of time to initiate deposition of the silane, wherein the silane at least partially deposits onto the silica;
(ii) mixing a solvent with the silane, adding the mixed solvent and silane to the silica, and using an elevated temperature for a period of time to initiate deposition of the silane, wherein the silane at least partially deposits onto the silica; or
(iii) spraying the silane on the silica, and using an elevated temperature for a period of time to initiate deposition of the silane, wherein the silane at least partially deposits onto the silica;
b. adding the pretreated silica to a carrier, forming a slurry;
c. heating the slurry until the slurry reaches a temperature equivalent to a temperature of a preheated polymeric rubber latex forming a heated slurry;
d. mixing the preheated polymeric rubber latex with the heated slurry to form a latex slurry; and
e. coagulating the latex slurry, forming the high silica loaded polymeric rubber composite with a polymeric rubber weight percent from 50 weight percent to 99 weight percent and a silica weight percent from 1 weight percent to 49 weight percent.

2. The method of claim 1, wherein the silane is an organosilicon derived from an organic silane having the structure: Z₁Z₂Z₃Si(CH₂)_{y}X(CH₂)_{y}SIZ₁Z₂Z₃, wherein X is a polysulfide, wherein y is an integer equal to or greater than 1; and wherein Z₁, Z₂, and Z₃ are each independently selected from the group consisting of hydrogen, alkoxy, halogen, and hydroxyl.

3. The method of claim 2, wherein the sulfur content ranges from 0.1 weight percent to 10 weight percent.

4. The method of claim 2, wherein the organosilicon: is bonded to a surface of the silica, has three readily hydrolyzable groups attached directly to a silicon atom of the organosilicon, and has at least one organic group attached directly to the silicon atom.

5. The method of claim 2, wherein the organosilicon is bonded to a surface of the silica and has an organic group attached directly to a silicon atom of the organosilicon that contains at least one functional group.

6. The method of claim 5, wherein the amount of the organosilicon that is bonded to the surface of the silica ranges from 2 weight percent to 25 weight percent per weight of the silica.

7. The method of claim 1, wherein the silane is an organosilicon derived from an organic silane having the structure 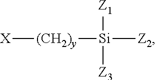
wherein:
a. X is a functional group selected from the group consisting of an amino group, a polyamino alkyl group, a mercapto group, a thiocyanato group, an epoxy group, a vinyl group, a halogen, an acryloxy group and a methacryloxy group;
b. y is an integer equal to or greater than 0; and
c. Z₁, Z₂, and Z₃ are each independently selected from the group consisting of hydrogen, alkoxy, halogen, and hydroxyl.

8. The method of claim 7, wherein the mercapto group has a sulfur content ranging from 0.1 weight percent to 10 weight percent.

9. The method of claim 7, wherein the organosilicon: is bonded to a surface of the silica, has three readily hydrolyzable groups attached directly to a silicon atom of the organosilicon, and has at least one organic group attached directly to the silicon atom.

10. The method of claim 7, wherein the organosilicon is bonded to a surface of the silica and has an organic group attached directly to a silicon atom of the organosilicon that contains at least one functional group.

11. The method of claim 9, wherein the amount of the organosilicon that is bonded to the surface of the silica ranges from 2 weight percent to 25 weight percent of the silica.

12. The method of claim 1, wherein the polymeric rubber latex comprises: styrene-butadiene rubber, acrylonitrile-butadiene rubber, polyvinylchloride, acrylonitrile-butadiene-styrene polymer, carboxylated styrene butadiene, carboxylated acrylonitrile-butadiene, styrene-acrylonitrile copolymer, polybutadiene, polyisoprene, polychloroprene, neoprene, polybutadiene-isoprene, or combinations thereof.

13. The method of claim 1, wherein the polymeric rubber latex comprises a copolymer of: styrene and butadiene, styrene and isoprene, styrene and acrylonitrile, or butadiene and acrylonitrile.

14. The method of claim 1, wherein the solvent is toluene, hexane, or another hydrocarbon solvent.

15. The method of claim 1, wherein the spraying of the silane on the silica is performed using an air carrier, and wherein the sprayed silane is mixed into the silica using a ribbon blender or a fluidized bed.

16. The method of claim 15, wherein the ribbon blender mixes at a rate ranging from 5 revolutions-per-minute to 20 revolutions-per-minute.

17. The method of claim 1, wherein the slurry of the carrier and the pretreated silica has: from 5 weight percent to 40 weight percent of the pretreatment silica and from 60 weight percent to 95 weight percent of the carrier.

18. The method of claim 1, wherein the high silica loaded polymeric rubber composite has from 5 parts per hundred rubber to 120 parts per hundred (phr) rubber of the pretreated silica.

19. The method of claim 1, wherein the coagulating of the latex slurry is initiated by adding to the latex slurry: a solution of calcium chloride, zinc chloride, salts of aluminum, salts of magnesium, sulfuric acid, citric acid coagulate, ferric chloride, isopropanol, or combinations thereof.

20. The method of claim 1, wherein at least a portion of the silane is chemically bonded to the silica.

21. The method of claim 1, further comprising adding to the preheated polymeric rubber latex an oil extender, forming the high silica loaded polymer rubber composite with 1 weight percent to 35 weight percent of pretreated silica, from 1 weight percent to 35 weight percent of an oil extender, and from 30 weight percent to 98 weight percent of polymeric rubber latex.

22. The method of claim 1, further comprising adding to the preheated polymeric rubber latex an antioxidant, forming the high silica loaded polymer rubber composite with 1 weight percent to 35 weight percent of pretreated silica, from 0.1 weight percent to 2 weight percent of an antioxidant, and from 67 weight percent to 99 weight percent of polymeric rubber latex.

23. The method of claim 1, further comprising adding to the slurry, a carbon black slurry comprising: from 4 weight percent to 6 weight percent carbon black in water, wherein the composition of the high silica loaded polymer rubber composite is from 1 weight percent to 35 weight percent silica, from 1 weight percent to 49 weight percent of carbon black, and from 16 weight percent to 98 weight percent polymeric rubber.
